(19) United States
(12) Patent Application Publication
(10) Pub. No.: US 2024/0181758 A1
(43) Pub. Date: Jun. 6, 2024

(54) INSULATION MATERIAL, METHOD FOR PRODUCING AN INSULATION MATERIAL, AND METHOD FOR RECYCLING AN INSULATION MATERIAL

(71) Applicant: LEONHARD KURZ Stiftung & Co. KG, Fürth (DE)

(72) Inventors: Mathias THÄTER, Fürth (DE); Uwe REUTHER, Fürth (DE); Ulrich SCHINDLER, Fürth (DE)

(21) Appl. No.: 18/287,705

(22) PCT Filed: Mar. 31, 2022
(86) PCT No.: PCT/EP2022/058519

§ 371 Date: Oct. 20, 2023

(30) Foreign Application Priority Data
Apr. 26, 2021 (DE) 10 2021 110 571.4

(51) Int. Cl. B32B 27/08; B32B 3/12

(52) U.S. Cl. CPC B32B 27/08; B32B 3/12; B32B 2255/205; B32B 2305/024; B32B 2305/08; B32B 2305/70; B32B 2307/304; B32B 2307/3065; B32B 2307/416; B32B 2307/7376

(57) ABSTRACT

An insulation material (1), a method for producing an insulation material (1), and a method for recycling an insulation material (1). The insulation material (1) has at least two layers, wherein at least one first layer (11) is formed as a reflector layer and at least one second layer (12) is formed as a spacing layer, wherein the at least one first layer (11) and the at least one second layer (12) in each case have polymeric constituents, wherein the polymeric constituents are formed of an unmixed polymeric material.

The invention relates to an insulation material, a method for producing an insulation material, and a method for recycling an insulation material.

It is known to use heat-insulating materials for thermal insulation. Here, a distinction is drawn between fibrous insulating materials, foam insulating materials and multilayer insulations (=MLI). In the case of an MLI, several plies of different layers are arranged one on top of another. All heat-insulating materials share the problem that they are not at all recyclable, or only to a very limited extent. Disposal is usually by combustion or in a landfill site. Here, not only are large amounts of resources destroyed, but a lot of hazardous substances are also released. The currently available MLI insulating materials consist of a wide variety of raw materials and additives, which make a recovery of such insulating materials for an equivalent product uneconomical or impossible.

The object of the invention is now to specify recyclable, sustainable and resource-efficient thermal insulation material which can be processed after use into an equivalent thermal insulation material again. The efficiency of the thermal insulation material in relation to the weight and to the total layer thickness is further to be increased. Furthermore, the chemical and physical resistance of the insulation material is also to be improved.

The object is achieved by an insulation material which has at least two layers, wherein at least one first layer is formed as a reflector layer and at least one second layer is formed as a spacing layer, wherein the at least one first layer and the at least one second layer in each case have polymeric constituents and wherein the polymeric constituents are formed of an unmixed polymeric material.

This object is further achieved by a method for producing an insulation material, in particular according to claims 1 to 33, wherein the following steps are carried out, in particular in the following order:
a) providing at least one first layer as a reflector layer with an upper side and an underside
b) providing at least one second layer as a spacing layer
c) joining the at least one first layer to the at least one second layer, in order to obtain an insulation material with at least two layers, wherein the at least one first layer and the at least one second layer in each case have polymeric constituents, wherein the polymeric constituents are formed of an unmixed polymeric material.

This object is furthermore achieved by a method for recycling an insulation material, in particular according to claims 1 to 33, in particular produced with a method according to claims 34 to 54, wherein in the method the following steps are carried out, in particular in the following order:
I) comminuting the insulation material by means of a comminution device
II) washing the comminuted insulation material by means of a cleaning device, wherein a washing liquid is used, and wherein inorganic constituents are released and/or precipitated and/or separated and/or recovered, with the result that an unmixed polymeric material is provided.

It has been shown here that, through the insulation material according to the invention, the method according to the invention for producing an insulation material and the method according to the invention for recycling an insulation material, an insulation material is obtained which can be almost completely recycled, and the products obtained therefrom can be used again to produce an insulation material. Because of the state of being unmixed, a product quality that always remains the same is also guaranteed. Because the at least one first layer and the at least one second layer have polymeric constituents made of an unmixed polymeric material, a complex separation of the individual layers can be dispensed with during the recycling. The insulation material can thus be comminuted directly. This increases the efficiency of the recycling process and, in addition, represents an extremely economical recycling method.

Further advantageous designs of the invention are described in the dependent claims.

By multilayer insulation or MLI is meant a multilayered thermal insulation material.

By reflector layer is meant a layer, in particular polymeric layer and/or film, which is coated or vapor-deposited on one or both sides with reflective material, in particular infrared-reflective material. The reflective material can be inorganic and/or metallic.

By spacing layer is meant a layer which represents a spatial separation between the layers. The layers are thereby kept at a distance and movements of air between the layers are minimized. It is thus a thermal separation, or insulation or insulating. The spacing layer preferably has polymeric constituents. It is also possible for the spacing layer to have non-polymeric constituents.

By polymeric constituents is meant polymers, such as for example PET, PE, PP, PA and/or biopolymers and/or the like, which can be processed to form fibers and films.

By unmixed is meant that the at least one first layer or reflector layer and the at least one second layer or spacing layer have the same polymeric material or the same polymeric constituents. The polymeric constituents can be recovered to make an equivalent product because of the state of being unmixed.

By inorganic constituents is meant all non-polymeric constituents which originate from the reflective layers, in particular infrared-reflective layers, from inorganic flame-retardant substances as well as impurities from the recycling process.

By foreign materials is meant materials joined to the insulation material which are delivered to a separate recycling stream.

It is preferably possible for the at least one first layer to have a layer thickness in the range of from 3 μm to 250 μm, in particular from 10 μm to 55 μm.

In particular, it can be provided that the at least one first layer has an upper side and an underside, wherein at least one reflective layer, in particular an infrared-reflective layer, is applied to the upper side and/or the underside of the at least one first layer. By upper side is always meant the surface which is directed towards an outside surface of the insulation material. It can be the case that the at least one first layer is also arranged on the inside of the insulation material. In this case, the side that is at the smaller distance from the center of the insulation material is always defined as the underside. The opposite side is then defined as the upper side. The at least one reflective layer serves to reflect incident radiation, in particular infrared radiation and/or heat radiation. Because incident radiation is reflected, the insulation properties of the insulation material are considerably improved.

It is preferably possible for the at least one reflective layer, in particular infrared-reflective layer, to comprise metals as material, individually or in combination and/or as an alloy, selected from: aluminum, silver, gold. The at least one reflective layer, in particular infrared-reflective layer, can additionally or alternatively have metal pigments and/or PVD pigments.

In particular, at least one binder is necessary to bind constituents of the reflective layer, in particular pigments and/or particles for applying the reflective layer by means of printing methods. It is preferably provided that the at least one binder has a polymer, preferably an unmixed polymer, for example based on polyester.

In particular if aluminum is used as a reflective layer, in particular infrared-reflective layer, the advantage results that the aluminum can be recovered during the recycling process. As described further below, aluminum hydroxide, which can be introduced into the at least one second layer as flame retardant during the production of the insulation material, is obtained from the aluminum. In addition, aluminum offers the advantage that it is cost-effective and can be deposited uniformly on the at least one first layer by means of vapor deposition, in particular in a vacuum.

In particular, it is provided that the at least one reflective layer, in particular infrared-reflective layer, reflects incident radiation, in particular infrared radiation, at a rate of 10% to 97%, preferably 60% to 97%. In particular if several first layers with reflective layer, in particular infrared-reflective layer, are used, the reflection effect in the overall composite of the layers with respect to incident radiation can be increased to up to 97%.

It is also possible for at least one absorbing layer, in particular infrared-absorbing layer, to be applied to the upper side and/or the underside of the at least one first layer. With respect to the definition of the upper side and the underside, the same statements as above apply. It is advantageous if the at least one first layer has a reflective layer on the upper side and an absorbing layer on the underside, or vice versa. It has been shown that the disadvantage of conventional façade insulating materials, of impeding the heating of a façade by solar radiation, can be reduced hereby.

It is preferably possible for the at least one absorbing layer, in particular infrared-absorbing layer, to comprise a material or combinations of materials selected from: carbon black, carbon, binder, metal, metal oxide.

It is preferably provided that at least one binder is necessary to bind the absorbing carbon black and/or carbon of the absorbing layer. The binder preferably comprises a polymer, in particular an unmixed polymer, for example based on polyester.

It is preferably provided that carbon black and/or carbon are separated by flotation in the recycling process and can be used again as an absorbing layer after a preparation.

It can be possible for the at least one absorbing layer, in particular infrared-absorbing layer, to absorb incident radiation, in particular infrared radiation, at a rate of 5% to 96%, preferably 75% to 96%. In particular if several absorbing layers are used, the absorption effect in the overall composite of the layers can be increased by the the superimposition of the absorbing layers.

It is preferably possible for the at least one reflective layer, in particular infrared-reflective layer, to have a thickness in the range of from 5 nm to 100 μm. In particular reflective layers, made of metals and/or metal oxides, vapor-deposited in high vacuum have a thickness of from 5 nm to 200 nm, in particular from 20 nm to 60 nm. Reflective coatings, having metal pigments and/or PVD pigments, applied by means of a printing method, in particular gravure printing and/or screen printing and/or flexographic printing, have a thickness of from 2 μm to 100 μm, in particular from 2 μm to 6 μm.

It is preferably possible for the at least one absorbing layer, in particular infrared-absorbing layer, to have a thickness in the range of from 5 nm to 100 μm. In particular absorbing layers, made of metals and/or metal oxides, vapor-deposited in high vacuum have a thickness of from 5 nm to 200 nm, in particular from 20 nm to 60 nm. Absorbing coatings, having carbon black and/or carbon, applied by means of a printing method, in particular gravure printing and/or screen printing and/or flexographic printing, have a thickness of from 2 μm to 100 μm, in particular from 2 μm to 6 μm.

It can also be possible for the at least one first layer to have at least one inhibiting layer, which is preferably arranged on and/or underneath the reflective layer, for improving the corrosion resistance. By inhibiting layer is meant a layer made of an inhibitor which improves the corrosion resistance of the at least one reflective layer. In particular, it is provided that the at least one inhibiting layer has a material or combinations of materials selected from: unmixed polymers, inorganic coatings, silicon oxide (SiOₓ), silicon dioxide (SiO₂).

It is preferably provided that at least one binder is provided to bind constituents of the inhibiting layer, in particular pigments and/or particles for applying the inhibiting layer by means of printing methods. The at least one binder is preferably a polymer, preferably an unmixed polymer, for example based on polyester.

It is preferably provided that the at least one second layer has a thickness in the range of from 0.5 mm to 120 mm, in particular from 2 mm to 5 mm, and/or has a surface weight in the range of from 10 g/m² to 2000 g/m², in particular from 50 g/m² to 200 g/m².

It is possible for example for the at least one second layer to be formed as a structured film and/or air- or gas-cushion film and/or foam and/or woven fabric and/or non-woven material, in particular fleece and/or felt and/or fibers and/or hollow fibers.

By non-woven materials is meant here all composite materials made of fibers which are spun, cut and/or laid. No woven composite materials come under the term non-woven. The at least one second layer can also comprise a combination of different structures, for example a combination of woven fabric and fleece, and/or several plies of fleece. Through the combination of different structures, the flexibility of the insulation material can be adapted individually. Thus, the insulation material can for example be made thin, thick, flexible and/or rigid and can be designed specifically for different fields of use. For example, a certain pliability of the insulation material is advantageous in the cladding of pipes, whereas a very rigid insulation material can be used, for example, in the cladding of house walls.

In particular, it is possible for the at least one second layer to have a grid structure and/or honeycomb structure and/or diamond-shaped structure. These structures function as supporting structures and ensure a certain strength of the at least one second layer. In addition, the cavities and/or chambers formed by the structures can be filled with gases and/or other substances in order thus to improve the insulating effect.

It is preferably also provided that the at least one second layer comprises several fibers, in particular wherein the fibers have different thicknesses and/or structures. It is also possible for the at least one second layer to have supporting structures which form two or more chambers, wherein the chambers are delimited by the supporting structures. These supporting structures increase the strength and/or rigidity of the insulation material. It is advantageous if the supporting structures comprises fibers with a thickness in the range of from 1 μm to 1000 μm, in particular from 10 μm to 100 μm, and/or that the supporting structures are formed as airtight polymeric structures.

It can also be provided that the two or more chambers are filled with several fibers with a thickness in the range of from 1 μm to 100 μm, in particular from 5 μm to 20 μm, and/or with at least one gas. For example, air can be used here as gas. To increase the efficiency, the chambers can also be filled with gases which have a lower heat conductivity than air. Such gases are, for example, argon, krypton, xenon and/or carbon dioxide. It is preferably also possible for the insulation material between the at least one first layer and the at least one second layer to be filled with at least one gas. For this, it is preferably provided that the at least one first layer is joined to the at least one second layer with linear airtight seams, in particular wherein the seams form at least one chamber, which is delimited by the surfaces of the at least one first layer and the at least one second layer as well as the seams. It can also be possible for the gas to be put between two plies of the same type, for example between two first layers arranged one on top of the other and/or between two second layers arranged one on top of the other.

It can also be possible for the at least one second layer to comprise at least one flame retardant or a combination of flame retardants selected from: inorganic flame retardant, inert gases, noble gases, inorganic vapor depositions, physically acting flame retardants, chemically acting flame retardants. In particular, it is provided that the at least one flame retardant has aluminum hydroxide Al(OH)₃, which preferably forms from the reflective layer comprising aluminum during the process of recycling the insulation material, in particular the at least one first layer. The aluminum of the reflective layer is processed further to form aluminum hydroxide by adding sodium hydroxide solution and then adding carbon dioxide. The aluminum hydroxide formed can thus function as a flame retardant again. Thus, the use of aluminum hydroxide is extremely resource-efficient and environmentally friendly because the aluminum needed for it is obtained from the process of recycling the insulation material.

It is preferably provided that the polymeric constituents comprise a material or a combination of materials selected from: PET (polyethylene terephthalate), PP (polypropylene), PE (polyethylene), PA (polyamide), biopolymer. In principle, those polymeric materials which can be processed in several cycles both to form films and to form fibers are suitable. At least one first layer and the at least one second layer advantageously have the same material. An unmixed recycling is thereby made possible, as a result of which an equivalent product in terms of quality is formed.

In particular, it is provided that the polymeric constituents have a purity in the range of 75% and 100%, preferably of 95% and 100%. In particular, “unmixed” is mentioned in the case of such a purity. This purity guarantees that an equivalent product can be formed again in the method of recycling the insulation material.

It is preferably also possible for the insulation material to have a number of from 2 to 30 layers, in particular from 5 to 15 layers, in particular wherein the insulation material comprises the at least one first layer one or more times and/or comprises the at least one second layer one or more times. Thus, it is possible for the insulation material to be formed of several first layers and several second layers. The several first layers can have different layer thicknesses and also be coated differently. For example, it is possible for one first layer to have both a reflective and an absorbing layer and for another first layer to have two reflective layers. It is also possible for several first or second layers to be arranged lying one on top of another. Through this arrangement, the insulation material can be influenced in terms of its strength, pliability and rigidity, and adapted to different fields of use.

In particular, it is provided that the insulation material has a thickness in the range of from 1 mm to 120 mm, in particular from 5 mm to 50 mm.

It can be possible for the insulation material to have at least one other recyclable foreign material, in particular wherein the at least one foreign material has a substance and/or a combination of substances selected from: molded parts and/or panels, in particular made of natural substances, plastics and/or metals, composite elements for the automotive sector, supporting elements, cladding elements, conventional thermal insulating materials, foams, mineral fibers, papermaking pulps, bark pulps, cork mats, wood fiber mats.

It is preferably provided that the at least one foreign material is arranged detachable from the at least one first layer and/or the at least one second layer. It is thereby achieved that before the process of recycling the insulation material the foreign material can be easily separated therefrom, for example by an air separation process downstream of the comminution process. The foreign material can then be delivered to a separate recycling process and the insulation material can be recovered unmixed.

In particular, it is possible for the at least one foreign material and/or the at least one first layer and/or the at least one second layer to be joined by means of a method and/or a combination of methods selected from: friction welding, ultrasonic welding, laser welding, thermal welding, adhesive bonding, stitching, mechanical tacking.

It is preferably provided that the at least one foreign material and/or the at least one first layer and/or the at least one second layer is joined by means of a joining element or a combination of joining elements selected from: tacking threads, in particular T-end tacking threads, pins, needles, nails, screws, rivets, studs.

In particular, it is possible for the insulation material to have predefined openings, in particular in the form of holes, cuts and/or perforations, preferably wherein these openings are formed as a membrane with a defined permeability for particular substances and/or wherein these openings are formed as a valve for material exchange in only one direction. Through the predefined openings, it is possible in addition for components, such as for example brackets, pipes, cables or the like, to be able to be guided through the insulation material in a simple manner. This makes handling and fitting substantially easier. In addition, through the openings, in particular the membranes and/or the valves, it is possible to guarantee an exchange of substances in the form of gases, air, water vapor and/or water with the environment. This aspect is important if physical spaces which themselves have different temperatures or relative humidities are joined via walls with this insulation material, and condensate formation is to be prevented. In other cases, openings make sense if such insulation materials are for example to be installed in turf structures with corresponding heating elements, and water drainage/conveyance is imperative. Such a water drainage/conveyance is brought about for example by precipitation in the form of rain or snow.

It can also be possible for the insulation material to have a reinforcement made of the unmixed polymeric material in the region of the openings. An increased stability of the insulation material is hereby guaranteed in the region of the openings, whereby possible damage in the region of the openings is to be prevented—for example when components are handled and guided through.

It is preferably provided that the insulation material has a reaction to fire classification of normally flammable, in particular “E”, or better under the heat of a standard flame of a fire test standardized according to DIN EN ISO 11925-2 and in accordance with DIN EN ISO 13501-1. The performance of the fire test and the classification is described in detail further below with the aid of the figures.

It is preferably also possible for the insulation material to have a burn rate of 0 mm/min under the heat of a standard flame of fire test standardized according to DIN 75200 and/or FMVSS 302, in particular to be classified as SE/NBR or “self-extinguishing/no burn rate” according to FMVSS 302. The performance of the fire test and the classification is described in detail further below with the aid of the figures.

In preferred embodiments it can also be provided that the at least one first layer and/or the at least one second layer is formed as a spacing layer and as a reflector layer. In this case, it is preferably a structured vapor-deposited film or a vapor-deposited air/gas cushion film. The surface of the film can be modified or structured via structured rollers in an extrusion process. In the process structures form which function as spacers because of their elevations and/or depressions. These structures preferably have a rough surface. With the aid of this rough surface, the insulation material can be better attached to the target material, as this rough surface can act as an anchoring, and thus an easy sliding of the insulation material is counteracted.

It can also be possible for example for the at least one first layer and the at least one second layer already to join to each other during the production because of their increased temperature and the resultant aggregate state. For example, it is possible for the at least one first layer to originate from an extrusion process and for the at least one second layer to be produced by means of a melt-blown process. In order to guarantee the joining of the at least one first layer to the at least one second layer, the two production processes are combined with each other, with the result that the two layers are joined to each other immediately after the extrusion process and the melt-blown process. The resulting insulation material then need only be assembled and joined together in a different and desired number of plies.

In particular, it is provided that the following step is further performed after step a) and before step b):
d) applying at least one reflective layer, in particular infrared-reflective layer, and/or at least one absorbing layer, in particular infrared-absorbing layer, to the upper side and/or the underside of the at least one first layer.

It can also be possible for this step already to be carried out during the production of the at least one first layer. In this case, a first layer already coated with reflective layer and/or absorbing layer is then provided in step a).

In particular, it is possible for aluminum, in particular silver or gold or combinations and/or alloys of these metals, to be applied in step d) as a reflective layer, in particular infrared-reflective layer. It can also be possible for metal pigments and/or PVD pigments to be applied as a reflective layer, in particular infrared-reflective layer, in particular by means of a printing method, in particular gravure printing and/or screen printing and/or flexographic printing.

It can also be possible for carbon black and/or carbon and/or metals and/or metal oxides and/or binders to be applied in step d) as an absorbing layer, in particular infrared-absorbing layer. It is preferably provided that the at least one absorbing layer, in particular infrared-absorbing layer, is applied in step d) by means of a printing method, in particular gravure printing and/or screen printing and/or flexographic printing. In the case where metals and/or metal oxides are applied in step d) as an absorbing layer, in particular infrared-absorbing layer, these are preferably applied by means of vapor deposition in high vacuum.

It is preferably possible for the at least one reflective layer to be applied in step d) with a thickness in the range of from 5 nm to 100 μm, preferably from 5 nm to 200 nm, particularly preferably from 20 nm to 60 nm. In particular reflective layers, made of metals and/or metal oxides, vapor-deposited in high vacuum have a thickness in the range of from 5 nm to 200 nm, in particular from 20 nm to 60 nm.

Reflective coatings, having metal pigments and/or PVD pigments, applied by means of a printing method, in particular gravure printing and/or screen printing and/or flexographic printing, have a thickness in the range of from 2 μm to 100 μm, in particular from 2 μm to 6 μm.

In particular, at least one binder is necessary to bind constituents of the reflective layer, in particular pigments and/or particles for applying the reflective layer by means of printing methods. It is preferably provided that the at least one binder has a polymer, preferably an unmixed polymer, for example based on polyester.

It is preferably possible for at least one absorbing layer, in particular infrared-absorbing layer, to be applied in step d) with a thickness in the range of from 5 nm to 100 μm, preferably from 20 nm to 60 nm, particularly preferably from 2 μm to 6 μm. In particular absorbing layers, made of metals and/or metal oxides, vapor-deposited in high vacuum have a thickness in the range of from 5 nm to 200 nm, in particular from 20 nm to 60 nm. Absorbing coatings, having carbon black and/or carbon, applied by means of a printing method, in particular gravure printing and/or screen printing and/or flexographic printing, are applied in a thickness in the range of from 2 μm to 100 μm, in particular from 2 μm to 6 μm.

It can also be possible for the at least one reflective layer and/or the at least one absorbing layer to be applied in step d) by means of vapor deposition, in particular in high vacuum. Particularly thin layer thicknesses can be realized through such a vapor deposition. In addition, a homogeneous application is made possible thereby.

It can also be possible for the at least one absorbing layer to be applied by means of a printing method, in particular by gravure printing and/or screen printing and/or flexographic printing.

In particular, at least one binder is necessary to bind in particular the absorbing carbon black and/or carbon of the absorbing layer. It is preferably provided that the at least one binder has a polymer, preferably an unmixed polymer, for example based on polyester.

It can preferably be possible for the following step further to be performed before and/or after step d):
e) applying at least one inhibiting layer to the at least one reflective layer, in particular by means of vapor deposition in high vacuum and/or by means of a printing method, in particular gravure printing and/or screen printing and/or flexographic printing.

Through the inhibiting layer, a corrosion protection is brought about which makes the insulation material more durable. It is preferably provided that the application of the at least one inhibiting layer is already effected during the production of the at least one first layer.

It is preferably also possible for the at least one inhibiting layer in step e) to have a material or combinations of materials selected from: unmixed polymers, inorganic coatings, silicon oxide (SiOₓ), silicon dioxide (SiO₂).

In particular, at least one binder is necessary to bind constituents of the inhibiting layer, in particular pigments and/or particles for applying the inhibiting layer by means of printing methods. It is preferably provided that the at least one binder has a polymer, preferably an unmixed polymer, for example based on polyester.

In particular, it is provided that the following step is further performed after step c):
f) introducing defined openings into the insulation material, in particular wherein the openings are introduced in the form of holes, cuts and/or perforations.

As already mentioned above, through the openings it is possible to guide components, such as for example brackets, pipes, cables or the like, through the insulation material in a simple manner.

It can also be possible for the openings to be introduced into the insulation material in step f) as a membrane with a defined permeability for particular substances and/or as a valve for material exchange in only one direction.

It is preferably provided that the openings are provided in step f) with reinforcements made of the unmixed polymeric material.

It can also be possible for the membranes and/or valves and/or reinforcements to be fixed to and/or in the insulation material in step f) by means of thermal methods and/or adhesive bonding. As a result, a firm bond with the insulation material forms and the valves or membranes are sealed with respect to the insulation material.

It is preferably possible for the following step further to be performed after step c):
g) joining the insulation material to at least one other recyclable foreign material, in particular wherein the at least one foreign material has a substance and/or a combination of substances selected from: molded parts and/or panels, in particular made of natural substances, plastics and/or metals, composite elements for the automotive sector, supporting elements, cladding elements, conventional thermal insulating materials, foams, mineral fibers, papermaking pulps, bark pulps, cork mats, wood fiber mats.

It is preferably provided that the at least one foreign material is arranged in step g) detachable from the at least one first layer and/or the at least one second layer. As already mentioned above, before the process of recycling the insulation material the foreign material can thus be separated therefrom. As a result, an unmixed recycling of the insulation material is made possible and the foreign material can be delivered to a separate recycling process.

In particular, it is possible for the at least one foreign material to be joined to the insulation material in step g) by means of a method and/or a combination of methods selected from: friction welding, ultrasonic welding, laser welding, thermal welding, adhesive bonding, stitching, mechanical tacking.

It can also be possible for the at least one foreign material to be joined to the insulation material in step g) by means of a joining element or a combination of joining elements selected from: tacking threads, in particular T-end tacking threads, pins, needles, nails, screws, rivets, studs. These joining elements are as a rule easy to release, with the result that the foreign material can be easily separated from the insulation material and the foreign material can be delivered to a separate recycling process.

It is preferably possible for one or more plies of the first layer and one or more plies of the second layer to be joined to form the insulation material in step c), with the result that the insulation material has a number of from 2 to 30 layers, in particular from 5 to 15 layers. In particular, it is provided that the at least one first layer and the at least one second layer are arranged one on top of the other in step c). As already mentioned above, through the combination of different plies the strength, pliability and rigidity of the insulation material can be adapted to the respective intended use.

It can also be possible for the at least one second layer provided, in particular spacing layer, to comprise in step b) at least one flame retardant or a combination of flame retardants selected from: inorganic flame retardant, inert gases, noble gases, inorganic vapor depositions, physically acting flame retardants, chemically acting flame retardants.

It is preferably possible for the at least one flame retardant to have aluminum hydroxide, which is preferably formed from the reflective layer comprising aluminum during the process of recycling the insulation material, in particular the at least one first layer. As already described above, the aluminum of the aluminum hydroxide is obtained from the at least one reflective layer during the recycling and processed further to form aluminum hydroxide by adding sodium hydroxide solution and carbon dioxide.

In particular, it is provided that the insulation material is filled with a gas before and/or during and/or after the joining in step c), in particular wherein the gas is enclosed in two or more chambers which are formed by supporting structures of the at least one second layer. It can also be provided that the gas is also introduced between the plies of the insulation material. For this, it is provided in particular that the at least one first layer and/or the at least one second layer are joined by means of linear airtight seams, for example by means of welding. It is preferably provided that the seams form at least one chamber, which are delimited by the surfaces of the at least one first layer and the at least one second layer as well as the seams. It is preferably provided that these chambers are filled with the gas.

It is preferably possible for the insulation material to be chopped and/or cut and/or shredded and/or torn in step I).

In particular, it is possible for a mixture of water (H₂O) and sodium hydroxide (NaOH) to be used as washing liquid in step II).

It is preferably provided that the inorganic constituents in step II) comprise aluminum, in particular wherein the aluminum originates from the at least one reflective layer of the at least one first layer of the insulation material, and that the aluminum reacts with the washing liquid, in particular the water and the sodium hydroxide solution, according to the reaction equation

2Al+6H₂O+2NaOH→2 Na[Al(OH)₄]+3H₂

to form a sodium aluminate solution Na[Al(OH)₄] and hydrogen H₂.

It can also be provided that the hydrogen forming is delivered to the thermal recovery. All products of the recycling method are thus recovered, which is particularly environmentally friendly and resource-efficient.

It is preferably possible for the sodium aluminate solution Na[Al(OH) 4] to react together with carbon dioxide, in particular wherein the carbon dioxide is taken from exhaust gas streams, in step II) according to the reaction equation

Na[Al(OH)₄]+CO₂→Al(OH)₃+NaHCO₃

to form aluminum hydroxide Al(OH)₃ and sodium hydrogen carbonate NaHCO₃. Because the carbon dioxide needed for the reaction is obtained from exhaust gas streams, the CO₂ footprint can be greatly reduced as the carbon dioxide is almost completely recovered in this reaction. The sodium hydrogen carbonate NaHCO₃ can be used again in particular as a flame retardant, as it splits off CO₂ during a heating then taking place, for example during a fire, and accordingly creates a fire-retardant atmosphere.

It is preferably provided that the aluminum hydroxide Al(OH)₃ formed, as well as the sodium hydrogen carbonate NaHCO₃, is used again as a flame retardant to produce a new insulation material. It is provided in particular that the aluminum hydroxide, as well as the sodium hydrogen carbonate, is used as a flame retardant in the production of the at least one second layer.

It is preferably provided to separate the carbon black and/or carbon originating from the absorbing layer from the washing liquid by means of flotation.

It is preferably provided that the carbon black and/or carbon is used again for the absorption layer of a new insulation material.

It is provided in particular that the carbon black and/or carbon is used in the production of an absorption layer.

It can also be possible for the following step further to be performed after step II):
III) drying the unmixed polymeric material by means of a drying device.

It is preferably provided that the dried unmixed polymeric material is used again to produce the at least one first layer and/or the at least one second layer of the insulation material.

The insulation material is used for example in the aerospace industry, in building construction, in the automotive sector, to protect temperature-sensitive goods and products during transport and storage. Because of the reflector layer of the insulation material, this is particularly advantageous in the case of use in the field of space travel. A vacuum prevails in space, with the result that heat radiation is the decisive variable with respect to insulation. The reflector layer can reflect this heat radiation.

In the following, the invention is explained by way of example with reference to several embodiment examples with the aid of the accompanying drawings. The embodiment examples shown are therefore not to be understood as limitative.

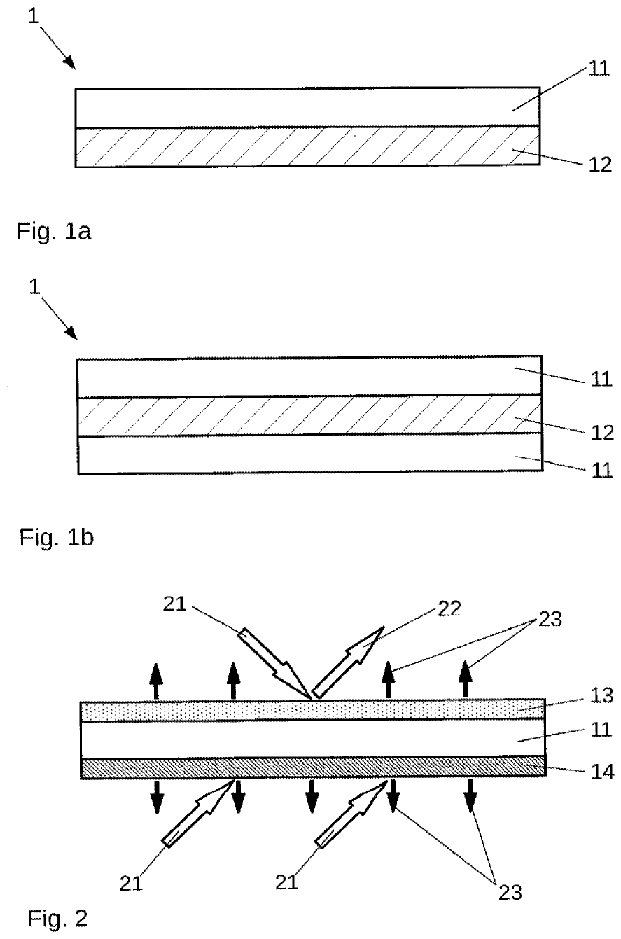

FIGS. 1a, b in each case show a schematic representation of an insulation material

FIG. 2 shows a schematic representation of a first layer as well as the functional principle of the reflective and absorbing layers with respect to radiation

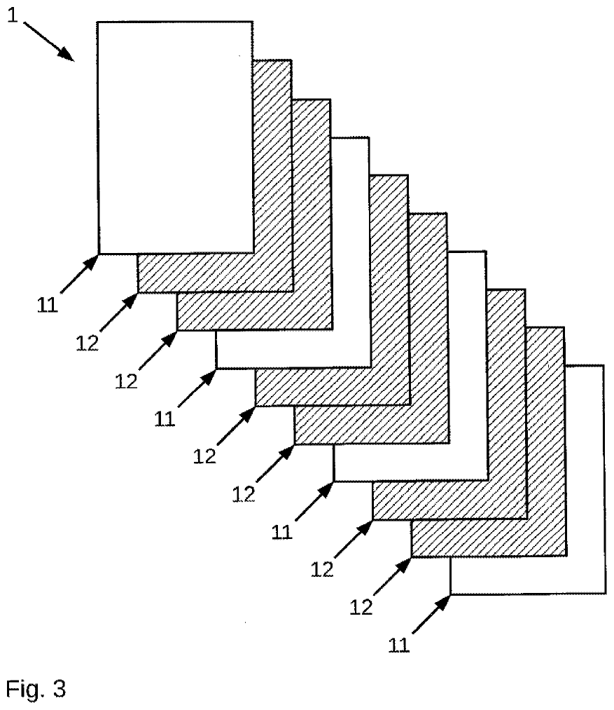

FIG. 3 shows an exploded view of an example insulation material with several plies

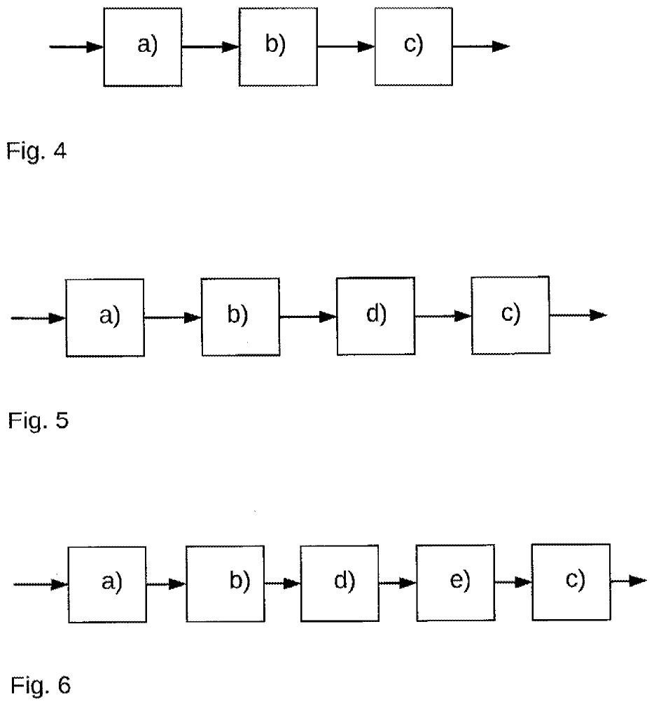

FIG. 4 shows a schematic representation of a method for producing an insulation material

FIG. 5 shows a schematic representation of a method for producing an insulation material

FIG. 6 shows a schematic representation of a method for producing an insulation material

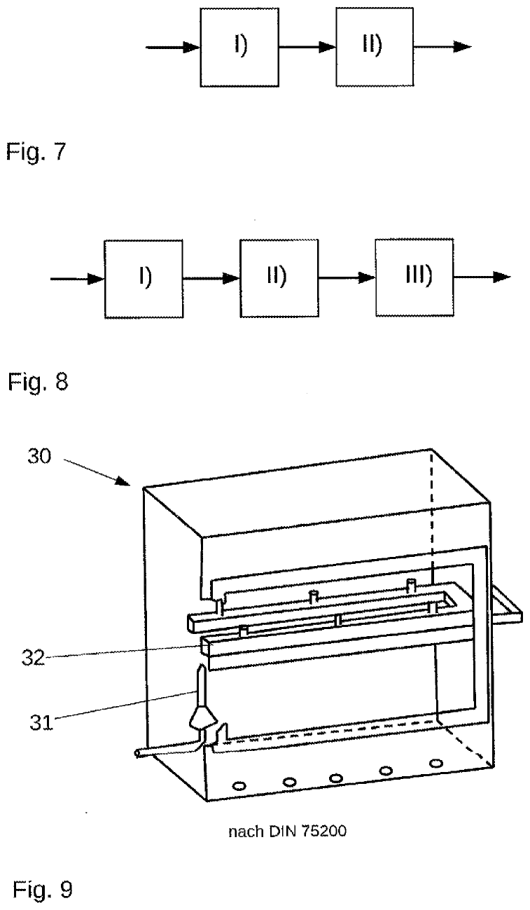

FIG. 7 shows a schematic representation of a method for recycling an insulation material

FIG. 8 shows a schematic representation of a method for recycling an insulation material

FIG. 9 shows a test setup according to DIN 75200 for determining the burning behavior of interior materials in motor vehicles

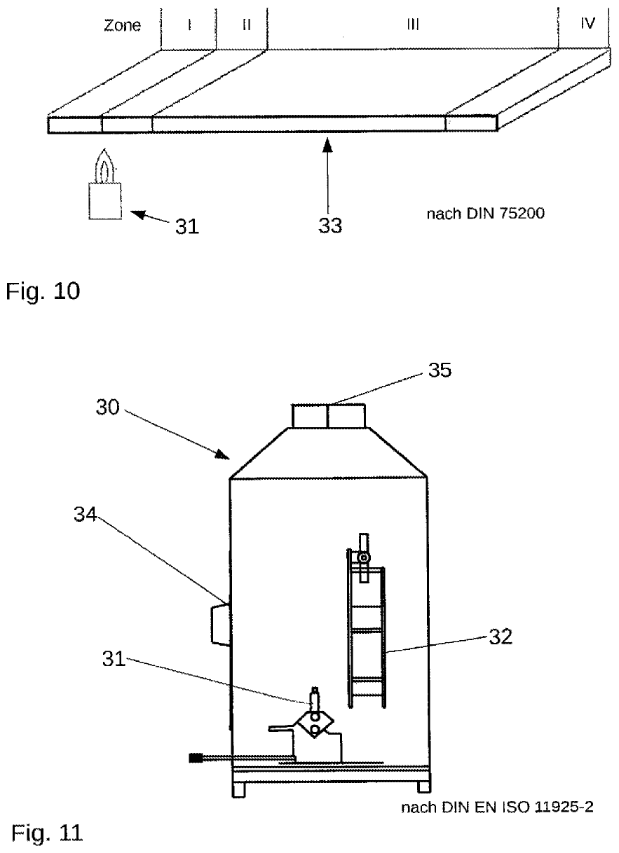

FIG. 10 shows the sample according to DIN 75200 for determining the burning behavior of interior materials in motor vehicles

FIG. 11 shows a test setup according to DIN EN ISO 11925-2

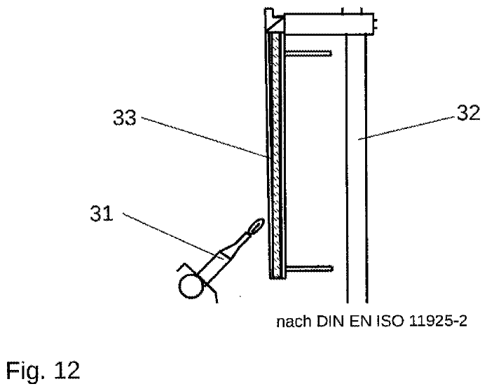

FIG. 12 shows a detailed view of the test setup according to DIN EN ISO 11925-2

FIG. 1a shows a schematic representation of an insulation material 1 with a first layer 11 and a second layer 12.

The first and second layers 11, 12 in each case have polymeric constituents, wherein the polymeric constituents are formed of an unmixed polymeric material. In other words, this means that the first layer 11 and the second layer 12 have substantially the same polymeric material. This offers the particular advantage that the insulation material 1 can be almost completely recycled and new insulation material 1 can be produced again from the recycled polymeric material forming.

In particular, it is provided that the polymeric constituents comprise a material or a combination of materials selected from: PET (polyethylene terephthalate), PP (polypropylene), PE (polyethylene), PA (polyamide), biopolymers. It is also preferably possible for the polymeric constituents to have a purity in the range of 75% and 100%, preferably of 95% and 100%. Such a purity of the polymeric constituents guarantees that after the recycling of the insulation material 1 the polymeric material forming has a high purity and also has the same physical and/or mechanical and/or chemical properties as the starting product.

A further embodiment example of an insulation material 1 is represented schematically in FIG. 1b. The insulation material 1 has two first layers 11 and a second layer 12. The two first layers 11 form the outer faces of the insulation material 1 and the second layer 12 is arranged as a spacing layer between the two first layers 11.

The insulation effect is improved by means of the spacing layer. For this, for example, the thickness of the spacing layer can be adapted. The thicker the spacing layer is formed, the better its insulation effect is. It is therefore preferably provided that the at least one second layer 12 has a thickness in the range of from 0.5 mm to 120 mm, in particular from 2 mm to 5 mm, and/or has a surface weight in the range of from 10 g/m² to 2000 g/m², in particular from 50 g/m² to 200 g/m².

It is preferably also possible for the at least one second layer 12 to be formed as a structured film and/or air- or gas-cushion film and/or foam and/or woven fabric and/or non-woven material, in particular fleece and/or felt and/or fibers and/or hollow fibers.

A first layer 11 is represented schematically in FIG. 2, wherein the first layer 11 has a reflective layer 13, in particular infrared-reflective layer, on its upper side and an absorbing layer 14, in particular infrared-absorbing layer, on its underside. The first layer 11 is preferably formed of a polymeric carrier and/or a polymeric film.

Further, it is preferably possible for the at least one first layer 11 to have a layer thickness in the range of from 3 μm to 250 μm, in particular from 10 μm to 55 μm.

The incident radiation 21 and the reflected radiation 22 are represented on the upper side by the unfilled arrows. Because of the reflective layer 13, the incident radiation 21 is reflected when it strikes the surface of the reflective layer 13, in particular with the result that the angle of reflection of the reflected radiation 22 corresponds to the angle of incidence of the incident radiation 21. However, a part of the incident radiation 21 is also emitted on the reflective layer 13. The emitted radiation 23 is represented by the filled arrows. The reflective layer 13 represented in this embodiment example is a layer made of aluminum. This layer is deposited during the production process preferably by means of vapor deposition, in particular in high vacuum. However, it is also possible for the first layer 11 also to be coated with the reflective layer 13 using other methods. A reflective layer 13 consisting of aluminum offers the advantage that during the recycling of the insulation material 1 the aluminum is processed further to form aluminum hydroxide, which can be used again as a flame retardant for the second layer 12 or the spacing layer of the insulation material 1. It is preferably also possible for the reflective layer 13 to comprise metals as material, individually or in combination and/or as an alloy, selected from: aluminum, silver, gold.

In the embodiment example in FIG. 2 the first layer 11 has an absorbing layer 14 on its underside. This absorbing layer 14 preferably comprises a material or combinations of materials selected from: carbon black and/or carbon and/or binders and/or metals and/or metal oxides. As represented in FIG. 2, incident radiation 21 is almost completely absorbed on the underside of the first layer 11, wherein it emits in all directions. The emitted radiation 23 is represented by the black-filled arrows. The effectiveness of the thermal insulation can thus be steered in a preferred direction by the alignment of the reflective and absorbing layers.

In particular, it is provided that the reflective layer 13 has a thickness in the range of from 5 nm to 100 μm. In particular reflective layers 13, made of metals and/or metal oxides, vapor-deposited in high vacuum have a thickness of from 5 nm to 200 nm, in particular from 20 nm to 60 nm. Reflective layers 13, having metal pigments and/or PVD pigments, applied by means of a printing method, in particular gravure printing and/or screen printing and/or flexographic printing, have a thickness of from 2 μm to 100 μm, in particular from 2 μm to 6 μm.

In particular, at least one binder is necessary to bind constituents of the reflective layer 13, in particular pigments and/or particles for applying the reflective layer 13 by means of printing methods. It is preferably provided that the at least one binder comprises a polymer, preferably an unmixed polymer, for example based on polyester.

In particular, it is provided that the absorbing layer 14, in particular infrared-absorbing layer, has a thickness in the range of from 5 nm to 100 μm. In particular absorbing layers 14, made of metals and/or metal oxides, vapor-deposited in high vacuum have a thickness of from 5 nm to 200 nm, in particular from 20 nm to 60 nm. Absorbing layers 14, made of carbon black and/or carbon, applied by means of a printing method, in particular gravure printing and/or screen printing and/or flexographic printing, have a thickness of from 2 μm to 100 μm, in particular from 2 μm to 6 μm.

In particular, at least one binder is necessary to bind in particular the absorbing carbon black and/or carbon of the absorbing layer 14. In particular, it is provided that the at least one binder has a polymer, preferably an unmixed polymer, for example based on polyester.

FIG. 3 shows a schematic exploded view of an insulation material 1. The insulation material 1 has a total of ten plies, wherein the two outer plies are in each case formed as a first layer 11 in the form of a reflector layer. Reflector layer means that the first layer 11 has at least one reflective layer 13, in particular infrared-reflective layer. The two outer plies preferably have a PET film with a thickness of 23 μm. The two outer plies are additionally coated on both sides, i.e. on their upper side and their underside, with an aluminum vapor deposition in a thickness of 30 nm. This aluminum vapor deposition acts as a reflective layer 13, in particular infrared-reflective layer.

The internal plies are both first layers 11 and second layers 12. The internal first layers 11 have a PET film with a thickness of 12 μm and are additionally provided with an aluminum vapor deposition on both sides in a thickness of 30 nm. Here too, the aluminum vapor deposition acts as a reflective layer 13, in order to reflect incident infrared radiation.

The internal second layers 12 have a PET fleece with a thickness of 1 mm and a surface weight of 70 g/m². The second layer 12 is additionally provided with aluminum hydroxide with a surface weight of 14 g/m². The aluminum hydroxide here functions as a flame retardant and was preferably obtained from the reflective layer 13 of the insulation material 1 during the recycling process.

The composite of the plies is produced for example using a friction welding method, such as for example ultrasonic welding, and/or by means of tacking threads.

FIG. 4 shows a method for producing an insulation material 1, wherein the following steps are carried out, in particular in the following order:
a) providing at least one first layer 11 as a reflector layer with an upper side and an underside
b) providing at least one second layer 12 as a spacing layer
c) joining the at least one first layer 11 to the at least one second layer 12, in order to obtain an insulation material 1 with at least two layers, wherein the at least one first layer 11 and the at least one second layer 12 in each case have polymeric constituents, wherein the polymeric constituents are formed of an unmixed polymeric material.

In the production of the insulation material 1 it is preferably provided that the same polymeric material is used to produce the first layer 11 and the second layer 12, in particular wherein the polymeric material originates from a process of recycling the insulation material 1.

It can be possible for the first layer 11 and the second layer 12 to be produced independently of one another and/or at different locations. However, it is also possible for the production of the first layer 11 and the second layer 12 to be effected at the same location and for the two layers 11, 12 to be joined to each other subsequently.

In particular, it is provided that one or more plies of the first layer 11 and one or more plies of the second layer 12 are joined to form the insulation material 1 in step c), with the result that the insulation material 1 has a number of from 2 to 30 layers, in particular from 5 to 15 layers.

A further embodiment variant of a method for producing an insulation material 1 is represented in FIG. 5. It contains substantially the same steps a), b) and c) as the method shown in FIG. 4, but with the difference that the following step is further performed after step b) and before step c):
d) applying at least one reflective layer 13, in particular infrared-reflective layer, and/or at least one absorbing layer 14, in particular infrared-absorbing layer, to the upper side and/or the underside of the at least one first layer 11.

In preferred embodiment variants it is possible for the application of the at least one reflective layer 13 and/or the at least one absorbing layer 14 already to be effected during the production of the at least one first polymeric layer 11.

In particular, it is provided that aluminum, in particular silver or gold or combinations and/or alloys of these metals, is applied in step d) as a reflective layer 13, in particular infrared-reflective layer.

It is preferably possible for carbon black and/or carbon and/or binders and/or metals and/or metal oxides to be applied in step d) as an absorbing layer 14, in particular infrared-absorbing layer.

In particular, at least one binder is necessary to bind in particular the absorbing carbon black and/or carbon of the absorbing layer 14. It is preferably provided that the at least one binder comprises a polymer, preferably an unmixed polymer, for example based on polyester.

Further, it is preferably provided that the at least one reflective layer 13 is applied in step d) with a thickness in the range of from 5 nm to 100 μm. In particular reflective layers 13, made of metals and/or metal oxides, vapor-deposited in high vacuum have a thickness of from 5 nm to 200 nm, in particular from 20 nm to 60 nm. Reflective layers 13, having metal pigments and/or PVD pigments, applied by means of a printing method, in particular gravure printing and/or screen printing and/or flexographic printing, have a thickness of from 2 μm to 100 μm, in particular from 2 μm to 6 μm.

Further, it is preferably provided that at least one absorbing layer 14, in particular infrared-absorbing layer, is applied in step d) a thickness in the range of from 5 nm to 100 μm. In particular absorbing layers 14, made of metals and/or metal oxides, vapor-deposited in high vacuum have a thickness of from 5 nm to 200 nm, in particular from 20 nm to 60 nm. Absorbing layers 14, having carbon black and/or carbon, applied by means of a printing method, in particular gravure printing and/or screen printing and/or flexographic printing, are applied in a thickness of from 2 μm to 100 μm, in particular from 2 μm to 6 μm.

It is also possible for the at least one reflective layer 13 and/or the at least one absorbing layer 14 to be applied in step d) by means of vapor deposition, in particular in high vacuum.

A further embodiment example of a method for producing an insulation material 1 is represented schematically in FIG. 6. The method substantially corresponds to the method represented from FIG. 5, but with the difference that the following step is further performed after step d):
e) applying at least one inhibiting layer to the at least one first layer 11 and/or the at least one reflective layer 13, in particular by means of vapor deposition in high vacuum and/or by means of a printing method, in particular gravure printing and/or screen printing and/or flexographic printing.

The at least one inhibiting layer serves to improve the corrosion resistance of the at least one first layer 11, in particular the reflective layer 13.

It is preferably provided that the at least one inhibiting layer in step e) has a material or combinations of materials selected from: unmixed polymers, inorganic coatings, silicon oxide (SiOₓ), silicon dioxide (SiO₂).

In particular, at least one binder is necessary to bind constituents of the inhibiting layer, in particular pigments and/or particles for applying the inhibiting layer by means of printing methods. It is preferably provided that the at least one binder has a polymer, preferably an unmixed polymer, for example based on polyester.

A method for recycling an insulation material 1 is represented in FIG. 7. In the method, the following steps are carried out, in particular in the following order:
I) comminuting the insulation material 1 by means of a comminution device
II) washing the comminuted insulation material 1 by means of a cleaning device, wherein a washing liquid is used, and wherein inorganic constituents are released and/or precipitated and/or separated and/or recovered, with the result that an unmixed polymeric material is provided.

For example a cutting mill can be used as comminution device in step I).

It is preferably possible for the insulation material 1 to be chopped and/or cut and/or shredded and/or torn in step I).

It is preferably provided that a mixture of water (H₂O) and sodium hydroxide (NaOH) is used as washing liquid in step II).

It has advantageously been shown that the inorganic constituents which comprise aluminum, in particular wherein the aluminum originates from the at least one reflective layer 13 of the at least one first layer 11 of the insulation material 1, and that the aluminum reacts with the washing liquid, in particular the water and sodium hydroxide, according to the reaction equation

2Al+6H₂O+2NaOH→2 Na[Al(OH)₄]+3H₂

to form a sodium aluminate solution Na[Al(OH)₄] and hydrogen H₂.

In particular, it is possible for the hydrogen forming to be delivered to the thermal recovery. The hydrogen can thus be used as energy carrier for other processes. In the method for recycling the insulation material 1, therefore, not only is the insulation material 1 recycled, but the added substances which are needed for recycling the insulation material 1 are also recovered again completely.

Further, it is preferably provided that the sodium aluminate solution Na[Al(OH)₄] reacts together with carbon dioxide CO₂, in particular wherein the carbon dioxide is taken from exhaust gas streams, in step II) according to the reaction equation

Na[Al(OH)₄]+CO₂→Al(OH)₃+NaHCO₃

to form aluminum hydroxide Al(OH)₃ and sodium hydrogen carbonate NaHCO₃. It is preferably provided that the carbon dioxide forms as a product of the combustion of fossil fuels and is taken from the resulting exhaust gas stream. The carbon dioxide regarded as ecologically harmful can thus be utilized for the production of the aluminum hydroxide. This method is particularly ecological and the CO₂ footprint is thus greatly improved.

A further embodiment example of a method for recycling an insulation material 1 is represented schematically in FIG. 8. This method corresponds to the method shown in FIG. 7, but with the difference that the following step is further performed after step II):
III) drying the unmixed polymeric material by means of a drying device.

It is possible in particular for the dried unmixed polymeric material to be used again to produce the at least one first layer 11 and/or the at least one second layer 12 of the insulation material 1.

A test setup for determining the burning behavior of interior materials in motor vehicles according to DIN 75200 (“Bestimmung des Brennverhaltens von Werkstoffen der Kraftfahrzeuginnenausstattung” [“Determination of burning behavior of interior materials in motor vehicles”]; DIN 75200:1980-09; issue date: 1980-09) is represented in FIG. 9. With respect to test setup and performance, as well as the assessment of the burn rate, DIN 75200 corresponds to the American standard FMVSS 302 (“Federal Motor Vehicle Safety Standard—49 CFR Part 571—FMVSS 302—Flammability of Interior Materials”; issue date: 02.12.1971; amendment level F. R. Vol. 63 No. 185—Sep. 24, 1998).

The test setup shown in FIG. 9 shows a burn cabinet 30 made of stainless steel, a sample holder 32, consisting of two U-shaped metal plates, located in the burn cabinet 30 and a burner 31 arranged in the burn cabinet 30. The sample 33 is clamped in the sample holder 32 such that the sample 33 does not sag. The sample holder 32 can be slid in and out of the burner 31. First, at the start of the test, the sample holder 32 with a sample 33 clamped therein is slid into the burn cabinet 30. The burner 31 is arranged in the burn cabinet 30 such that the nozzle center is located 19 mm below the center of the outer edge of the free end of the sample 33.

The gas needed to operate the burner 31 is to have a heating value of approximately 38 MJ/m³. The burner 31 is then adjusted with the aid of a measuring mark such that the gas flame has a height of 38 mm. At least one minute is necessary as precombustion time. Once the precombustion time has elapsed, the sample holder 32 is slid into the burn cabinet 30. The sample 33 is now exposed to the gas flame for a duration of 15 seconds. At the end of this time, the burner 31 is turned off. The measurement of the burn time begins as soon as the flame on the sample 33 has reached zone II, thus has covered a burn distance of exactly 38 mm. The division of the sample 33 into four zones according to DIN 75200 is represented in FIG. 10. In total, the sample 33 has a length of 356 mm. These are subdivided into four zones. Zones I, Il and IV are 38 mm long in each case and zone III is 216 mm long. The zones are arranged in increasing order starting with zone I up to zone IV. Measuring marks are arranged in each case between the zones, with the result that the flame's transition into the next zone can be detected more precisely. The flame propagation is observed on the faster burning side of the sample 33 (upper side or underside). The measurement of the burn time is to end when the flame has reached the last measuring mark or if the flame goes out before reaching the last measuring mark.

If the flame does not reach the last measuring mark, the burn distance that the flame has covered up to its extinguishment is measured. The decomposed part of the sample 33, which is destroyed by burning on the surface or on the inside, is regarded as the burn distance.

If the sample 33 is ignited and does not continue to burn once the igniting flame has been extinguished, or goes out before reaching the first measuring mark, no burn time is measured. In these cases, “burn rate=0” is recorded as the result.

In the case of repeat or serial testing, care is to be taken that the temperature of the burn cabinet 30 and of the sample holder 32 lies below 30° C. before a new test is started.

In addition to the burn rate, still further assessment criteria, which are listed in the following table, are contained in the American standard FMVSS 302:

| Evaluation | Description |
|---|---|
| DNI | does not ignite |
| | The material cannot be kept burning during or after ignition |
| SE | self-extinguishing |
| | The material burns, but goes out within zone I, i.e. within the |
| | first 38 mm (no burn distance covered) |
| SE/NBR | self-extinguishing/no burn rate |
| | The material goes out within 60 seconds from the start of the |
| | time measurement; the burn distance lies within zone II, i.e. |
| | under 38 mm. |
| SE/BR | self-extinguishing/burn rate |
| | The flame goes out within the total measurement path, i.e. |
| | within zone III, but has covered a burn distance of more than |
| | 38 mm from the measurement start. |
| | The burn rate B is calculated from the burn distance and time. |
| | B = burn distance [mm]/burn time [min] × 60 |
| BR | burn rate |
| | The flame covers the total burn distance within a particular |
| | time, i.e. the sample burns completely. The burn rate B is |
| | indicated. |
| | B = burn distance [mm]/burn time [min] × 60 |

It is preferably provided that the insulation material 1 has a burn rate of 0 mm/min under the heat of a standard flame of fire test standardized according to DIN 75200 and/or FMVSS 302, in particular is classified as SE/NBR or “self-extinguishing/no burn rate” according to FMVSS 302. In observations, it has been shown that the flame already goes out in zone Il and thus substantially only burns a hole in the insulation material 1. This is to be substantiated by the fact that the insulation material 1 escapes the flame by melting. In the process the insulation material 1 contracts and the flame goes out.

A test setup according to DIN EN ISO 11925-2 (“Prüfungen zum Brandverhalten—Entzündbarkeit von Produkten bei direkter Flammeneinwirkung—Teil 2: Einzelflammentest (ISO 11925-2:2020); German version EN ISO 11925-2:2020” [“Reaction to fire tests—Ignitability of products subjected to direct impingement of flame—Part 2: Single-flame source test”], issue date: 2020-07) is represented schematically in FIG. 11. This standard sets a test method for determining the ignitability of products by means of a directly acting flame without additional heat radiation. With this test setup, the classification of construction products with regard to the reaction to fire and the dripping behavior is effected according to DIN EN 13501-1 (“Klassifizierung von Bauprodukten und Bauarten zu ihrem Brandverhalten-Teil 1: Klassifizierung mit den Ergebnissen aus den Prüfungen zum Brandverhalten von Bauprodukten; German version EN 13501-1:2018” [“Fire classification of construction products and building elements—Part 1: Classification using data from reaction to fire tests”], issue date: 2019-05). The test according to DIN EN ISO 11925-2 simulates the strain on a product from the flame of a match or lighter. In the process the vertical flame propagation and the dripping behavior are investigated.

A burn cabinet 30 set up draft-free with a door 34 and a vent 35 is represented in FIG. 11. A burner 31 and the sample holder 32, in which the sample 33 is clamped, are located in the burn cabinet 30. A detailed view according to DIN EN ISO 11925-2, in which the sample holder 32, the sample 33 and the burner 31 are shown, is represented in FIG. 12.

With respect to the classification, a distinction is drawn between a 15-second flame impingement and a 30-second flame impingement. In the process a 20 mm long flame is directed onto the edge or surface of the sample 33. If the sample 33 is a construction product, these are tested according to DIN EN 13501-1 only with a surface flame impingement, if a direct flame impingement cannot occur on the edge in the intended practical application. This is the case for example for floor coverings. If edges can be strained by fire in the practical application, both surface and edge flame impingements are carried out. In the case of a surface flame impingement the flame is directed onto the center of the sample 33, 40 mm beyond the lower edge, and in the case of an edge flame impingement the flame is directed onto the center of the lower edge of the sample 33.

The sample 33 has dimensions of 250 mm×90 mm×d, wherein d=application thickness (<60 mm). For the test according to DIN EN ISO 11925-2 eight samples 33 are needed per product alignment, wherein by product alignment is meant transverse or longitudinal, and twelve samples 33 are needed in each case for multilayered products. For each type of flame impingement three samples 33 are tested, in each case in the longitudinal and transverse direction. Additional tests are carried out for multilayered products with a thickness of more than 10 mm. In the additional tests, the sample 33 is rotated by 90° about its vertical axis and flame impingement is effected on the respective center line of the different layers, in each case on the lower edge.

It is evaluated whether the flame tip exceeds a measuring mark at a height of 150 mm within the evaluation period and whether a filter paper lying under the sample 33 is ignited by material falling down. The evaluation period is 20 seconds in the case of the 15-second flame impingement and the evaluation period is 60 seconds in the case of the 30-second flame impingement.

The evaluation classification according to DIN 4102 and DIN13501-1 is represented in the following table:

Building material classes according
to DIN 4102 and DIN EN 13501-1

| | Additional requirement | | | |
|---|---|---|---|---|
| | No | No | DIN EN | DIN 4102- |
| German building | smoke | flaming | 13501-1 | 1 building |
| authority | devel- | droplets/ | reaction to | material |
| designation | opment | debris | fire class | class |
| Non-combustible | X | X | A1 | A1 |
| without | | | | |
| combustible | | | | |
| constituents | | | | |
| Non-combustible | X | X | A2-s1, d0 | A2 |
| with combustible | | | | |
| constituents | | | | |
| Flame-retardant | X | X | B; C-s1, d0 | B1 |
| | | | A2; B; C-s2, d0 | |
| | | X | A2; B; C-s3, d0 | |
| | X | | A2; B; C-s1, d1 | |
| | X | | A2; B; C-s1, d2 | |
| | | | A2; B; C-s3, d2 | |
| Normally | X | X | D-s1, d0 | B2 |
| flammable | | X | D-s2, d0 | |
| | | X | D-s3, d0 | |
| | X | | D-s1, d2 | |
| | | | D-s1, d2 | |
| | | | D-s1, d2 | |
| | | X | E | |
| | | | E-d2 | |
| Easily flammable | | | | B3 |

It is preferably provided that the insulation material 1 has a reaction to fire classification of normally flammable, in particular “E”, or better under the heat of a standard flame of a fire test standardized according to DIN EN ISO 11925-2 and in accordance with DIN EN ISO 13501 1.

### LIST OF REFERENCE NUMBERS

1 insulation material
11 first layer
12 second layer
13 reflective layer
14 absorbing layer
21 incident radiation
22 reflected radiation
23 emitted radiation
30 burn cabinet
31 burner
32 sample holder
33 sample
34 door
35 vent

1. An insulation material which has at least two layers, wherein at least one first layer is formed as a reflector layer and at least one second layer is formed as a spacing layer, wherein
the at least one first layer and the at least one second layer in each case have polymeric constituents, wherein the polymeric constituents are formed of an unmixed polymeric material.

2. The insulation material according to claim 1, wherein
the at least one first layer has a layer thickness in the range of from 3 μm to 250 μm.

3. The insulation material according to claim 1, wherein
the at least one first layer has an upper side and an underside, wherein at least one reflective layer is applied to the upper side and/or the underside of the at least one first layer.

4. The insulation material according to claim 3, wherein
the at least one reflective layer comprises metals as material, individually or in combination and/or as an alloy, selected from: aluminum, silver, gold.

5. The insulation material according to claim 3, wherein
the at least one reflective layer reflects incident radiation at a rate of 10% to 97%.

6. The insulation material according to claim 3, wherein
at least one absorbing layer is applied to the upper side and/or the underside of the at least one first layer.

7. The insulation material according to claim 6, wherein
the at least one absorbing layer comprises a material or combinations of materials selected from: carbon black, carbon, binder, metal, metal oxide.

8. The insulation material according to claim 6, wherein
the at least one absorbing layer absorbs incident radiation at a rate of 5% to 96%.

9. The insulation material according to claim 3, wherein
the at least one reflective layer has a thickness in the range of from 5 nm to 100 μm.

10. The insulation material according to ene of claim 3, wherein
the at least one absorbing layer has a thickness in the range of from 5 nm to 100 μm, in the case of layers, made of metals and/or metal oxides, vapor-deposited in high vacuum or a thickness in the range of from 2 μm to 6 μm in the case of layers, made of carbon black and/or carbon, applied by means of printing method.

11. The insulation material according to claim 1, wherein
the at least one first layer has at least one inhibiting layer, for improving the corrosion resistance.

12. The insulation material according to claim 11, wherein
the at least one inhibiting layer has a material or combinations of materials selected from: unmixed polymers, inorganic coatings, silicon oxide (SiOₓ), silicon dioxide (SiO₂).

13. The insulation material according to claim 1, wherein,
the at least one second layer has a thickness in the range of from 0.5 mm to 120 mm, and/or has a surface weight in the range of from 10 g/m² to 2000 g/m².

14. The insulation material according to claim 1, wherein
the at least one second layer is formed as a structured film and/or air- or gas-cushion film and/or foam and/or woven fabric and/or non-woven material.

15. The insulation material according to claim 1, wherein
the at least one second layer has a grid structure and/or honeycomb structure and/or diamond-shaped structure.

16. The insulation material according to claim 1, wherein,
the at least one second layer comprises several fibers.

17. The insulation material according to claim 1, wherein
the at least one second layer has supporting structures which form two or more chambers, wherein the chambers are delimited by the supporting structures.

18. The insulation material according to claim 17, wherein
the supporting structures comprises fibers with a thickness in the range of from 1 μm to 1000 μm, and/or wherein the supporting structures are formed as airtight polymeric structures.

19. The insulation material according to claim 17, wherein
the two or more chambers are filled with several fibers with a thickness in the range of from 1 μm to 100 μm, and/or with at least one gas.

20. The insulation material according to claim 1, wherein
the at least one second layer comprises at least one flame retardant or a combination of flame retardants selected from: inorganic flame retardant, inert gases, noble gases, inorganic vapor depositions, physically acting flame retardants, chemically acting flame retardants.

21. The insulation material according to claim 20, wherein
the at least one flame retardant has aluminum hydroxide Al(OH)₃.

22.-29. (canceled)

30. The insulation material according to claim 1, wherein
the insulation material has predefined openings.

31. The insulation material according to claim 30, wherein
the insulation material has a reinforcement made of the unmixed polymeric material in the region of the openings.

32. The insulation material according to claim 1, wherein
the insulation material has a reaction to fire classification of normally flammable, or better under the heat of a standard flame of a fire test standardized according to DIN EN ISO 11925-2 and in accordance with DIN EN ISO 13501-1.

33. The insulation material according to claim 1, wherein
the insulation material has a burn rate of 0 mm/min under the heat of a standard flame of fire test standardized according to DIN 75200 and/or FMVSS 302.

34. A method for producing an insulation material wherein the following steps are carried out:
a) providing at least one first layer as a reflector layer with an upper side and an underside
b) providing at least one second layer as a spacing layer
c) joining the at least one first layer to the at least one second layer, in order to obtain an insulation material with at least two layers, wherein the at least one first layer and the at least one second layer in each case have polymeric constituents, wherein the polymeric constituents are formed of an unmixed polymeric material.

35. The method according to claim 34, wherein
the following step is further performed after step a) and before step b):
d) applying at least one reflective layer and/or at least one absorbing layer to the upper side and/or the underside of the at least one first layer.

36. The method according to claim 35, wherein
aluminum, is applied in step d) as a reflective layer.

37. The method according to claim 35, wherein
carbon black and/or carbon and/or metals and/or metal oxides and/or binders are applied in step d) as an absorbing layer.

38.-40. (canceled)

41. The method according to claim 35, wherein
the following step is further performed before and/or after step d):
e) applying at least one inhibiting layer to the at least one first layer and/or the at least one reflective layer.

42. The method according to claim 41, wherein
the at least one inhibiting layer in step e) has a material or combinations of materials selected from: unmixed polymers, inorganic coatings, silicon oxide, (SiOₓ), silicon dioxide (SiO₂).

43. The method according to claim 34, wherein
the following step is further performed after step c):
f) introducing defined openings into the insulation material.

44. The method according to claim 43, wherein
the openings are introduced into the insulation material in step f) as a membrane with a defined permeability for particular substances and/or as a valve for material exchange in only one direction.

45. The method according to claim 43, wherein
the openings are provided in step f) with reinforcements made of the unmixed polymeric material.

46.-51. (canceled)

52. The method according to claim 34, wherein
the at least one second layer provided, comprises in step b) at least one flame retardant or a combination of flame retardants selected from: inorganic flame retardant, inert gases, noble gases, inorganic vapor depositions, physically acting flame retardants, chemically acting flame retardants.

53. The method according to claim 52, wherein
the at least one flame retardant has aluminum hydroxide, comprising aluminum during the process of recycling the insulation material.

54. The method according to claim 34, wherein
the insulation material is filled with a gas before and/or during and/or after the joining in step c).

55. A method for recycling an insulation material according to claim 1, wherein in the method the following steps are carried out:
I) comminuting the insulation material by means of a comminution device
II) washing the comminuted insulation material by means of a cleaning device, wherein a washing liquid is used, and wherein inorganic constituents are released and/or precipitated and/or separated and/or recovered, with the result that an unmixed polymeric material is provided.

56. The method according to claim 55,
a mixture of water (H₂O) and sodium hydroxide (NaOH) is used as washing liquid in step II).

57. The method according to claim 55, wherein
the inorganic constituents in step II) comprise aluminum, and wherein the aluminum reacts with the washing liquid, according to the reaction equation
2Al+6H₂O+2NaOH→2 Na[Al(OH)₄]+3H₂
to form a sodium aluminate solution Na[Al(OH)₄] and hydrogen H₂.

58. The method according to claim 57, wherein
the hydrogen forming is delivered to the thermal recovery.

59. The method according to claim 57, wherein
the sodium aluminate solution Na[Al(OH)₄] reacts together with carbon dioxide, in step II) according to the reaction equation
Na[Al(OH)₄]+CO₂→Al(OH)₃+NaHCO₃
to form aluminum hydroxide Al(OH)₃ and sodium hydrogen carbonate NaHCO₃.

60. The method according to claim 55, wherein
the following step is further performed after step II):
III) drying the unmixed polymeric material by means of a drying device.

61. The method according to claim 60, wherein
the dried unmixed polymeric material is used again to produce the at least one first layer and/or the at least one second layer of the insulation material.
